(19) United States
(12) Patent Application Publication
(10) Pub. No.: US 2025/0176070 A1
(43) Pub. Date: May 29, 2025

(54) METHOD AND APPARATUS FOR HANDLING PAGING EARLY INDICATION WITH PAGING SUBGROUPING ASSISTANCE

(71) Applicant: Samsung Electronics Co., Ltd., Suwon-si, Gyeonggi-do (KR)

(72) Inventors: Danish Ehsan HASHMI, Bangalore (IN); Lalith KUMAR, Bangalore (IN); Koustav ROY, Bangalore (IN); Arijit SEN, Bangalore (IN)

(21) Appl. No.: 18/724,954

(22) PCT Filed: Dec. 29, 2022
(86) PCT No.: PCT/KR2022/021592

§ 371 Date: Jun. 27, 2024

(30) Foreign Application Priority Data
Dec. 29, 2021 (IN) 202141061622
Dec. 15, 2022 (IN) 2021 41061622

(51) Int. Cl. H04W 76/50; H04W 36/08; H04W 60/04; H04W 68/02

(52) U.S. Cl. CPC H04W 76/50; H04W 36/08; H04W 60/04; H04W 68/02

(57) ABSTRACT

The disclosure relates to a 5G or 6G communication system for supporting a higher data transmission rate. A method performed by a UE in a wireless network, comprising performing a registration procedure indicating support of a first paging subgrouping; receiving, from an AMF, a negotiated PEIPS assistance information in a registration accept message during registration procedure; using a PEIPS assistance information; establishing an emergency PDU session over a first access network; stopping to use PEIPS assistance information; performing handover procedure of the emergency PDU session from first access network to a second access network; and in case that emergency PDU session is handed over from first access network to second access network, using PEIPS assistance information.

### CROSS-REFERENCE TO RELATED APPLICATION(S)

This application is a U.S. National Stage application under 35 U.S.C. § 371 of an International application number PCT/KR2022/021592, filed on Dec. 29, 2022, which is based on and claims priority of an Indian Provisional patent application No. 20/214,1061622, filed on Dec. 29, 2021, in the Indian Patent Office, and of an Indian Complete patent application No. 202141061622 filed on Dec. 15, 2022, in the Indian Patent Office, the disclosure of each of which is incorporated by reference herein in its entirety.

### TECHNICAL FIELD

Embodiments disclosed herein relate to wireless communication networks, and more particularly to managing paging indications in the wireless communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Solution

The principal object of the embodiments herein is to disclose systems (or wireless network) and methods to handle paging early indication efficiently, wherein a UE and an AMF entity shall not use Paging Early Indication Paging Subgroup (PEIPS) assistance information (i.e. PEIPS is disabled locally in the UE and the AMF entity), when an emergency PDU session is handover (HO) to 3GPPA (3GPP access) or an emergency PDU session is activated over the 3GPPA; and the UE and the AMF shall use PEIPS assistance information (i.e., PEIPS is enabled locally in the UE and the AMF) when the emergency PDU session is HO to N3GPPA or an emergency PDU session is released over 3GPPA or successful transfer of the emergency PDU session in a fifth generation system (5GS) over 3GPP access to a Evolved Packet Core (EPC), or an evolved packet data gateway (ePDG) connected to the EPC has occurred.

Another object of the embodiments herein is to disclose the UE initiating registration procedure (e.g., Registration procedure for mobility and periodic registration update) to indicate its capability to support NR paging subgrouping in the REGISTRATION REQUEST message after the emergency PDU session is released or successful transfer of the emergency PDU session in a fifth generation system (5GS) over 3GPP access to a Evolved Packet Core (EPC), or an evolved packet data gateway (ePDG) connected to the EPC has occurred, if the UE has indicated NR paging subgrouping is not supported in the previous REGISTRATION REQUEST message due to active emergency PDU session over the 3GPP access.

Another object of the embodiments herein is to disclose the UE initiating registration procedure for mobility and periodic registration update in the 3GPP access if the UE is in a 5GMM-REGISTERED over the 3GPP access or Initial registration if the UE in the 5GMM-DEREGISTERED state over the 3GPP access to indicate its capability to support NR paging subgrouping in the REGISTRATION REQUEST message after the emergency PDU session is released (over 3GPP access or non-3GPP access or on the EPC) or successful transfer of the emergency PDU session in a fifth generation system (5GS) over 3GPP access to a Evolved Packet Core (EPC), or an evolved packet data gateway (ePDG) connected to the EPC has occurred, if the UE has indicated NR paging subgrouping is not supported in the previous REGISTRATION REQUEST message due to active emergency PDU session over the 3GPP access.

Another object of the embodiments herein is to disclose the UE indicating its capability to support NR paging subgrouping registration procedure (e.g. in the initial registration procedure or Registration procedure for mobility and periodic registration update), when emergency PDU session is not active on the 3GPP access on 5GC (i.e. emergency PDU session or PDN connection is active on non-3GPP access, EPC/ePDG) and if AMF support PEIPS feature then it shall provide negotiated PEIPS assistance information in the registration accept.

Accordingly, the embodiments herein provide methods for handling a paging early indication with Paging Subgrouping Assistance (PEIPS) in a wireless network. The method includes triggering, by a UE, a registration procedure indicating support of a new Radio (NR) paging subgrouping. Further, the method includes starting to use, by the UE, a negotiated PEIPS assistance information in response to receiving the negotiated PEIPS assistance information in a registration accept message. Further, the method includes stopping to use, by the UE, the negotiated PEIPS assistance information in response to establishing emergency Packet Data Unit (PDU) session over a 3^{rd} Generation Partnership Project (3GPP) access. Further, the method includes determining, by the UE or an Access and Mobility Function (AMF) entity, that at least one of: a successful completion of a handover of the emergency PDU session from the 3GPP access to a non-3GPP access has occurred, or a successful transfer of the emergency PDU session in a fifth generation system (5GS) to an Evolved Packet Core (EPC), or an evolved packet data gateway (ePDG) connected to the EPC has occurred. Further, the method includes restarting to use, by the UE or the AMF, the negotiated PEIPS assistance information based on the determination.

Accordingly, the embodiments herein provide methods for handling a paging early indication (PEI) in a wireless network. The method includes determining, by a UE, that the UE supporting NR paging subgrouping did not indicate its capability to support the NR paging subgrouping during a last registration procedure in response to determining that an emergency Packet Data Unit (PDU) session over a 3GPP access is active. Further, the method includes initiating, by the UE, a registration procedure for a mobility and periodic registration after an emergency PDU session is released or successful transfer of the emergency PDU session in a fifth generation system (5GS) over 3GPP access to an Evolved Packet Core (EPC), or an evolved packet data gateway (ePDG) connected to the EPC has occurred. Further, the method includes indicating, by the UE, a UE capability to support new radio (NR) paging subgrouping in a registration request message during the registration procedure.

Accordingly, the embodiments herein provide a UE comprising a PEI controller coupled with a processor and a memory. The PEI controller is configured to trigger a registration procedure indicating support of a NR paging subgrouping. Further, the PEI controller is configured to start to use a negotiated PEIPS assistance information in response to receiving the negotiated PEIPS assistance information in a registration accept message. Further, the PEI controller is configured to stop to use the negotiated PEIPS assistance information in response to establishing emergency Packet Data Unit (PDU) session over a 3^{rd} Generation Partnership Project (3GPP) access. Further, the PEI controller is configured to determine that at least one of: a successful completion of a handover of the emergency PDU session from the 3GPP access to a non-3GPP access has occurred, or a successful transfer of the emergency PDU session in a fifth generation system (5GS) to an Evolved Packet Core (EPC), or an evolved packet data gateway (ePDG) connected to the EPC has occurred. Further, the PEI controller is configured to restart to use the negotiated PEIPS assistance information based on the determination.

Accordingly, the embodiments herein provide an AMF entity including a PEI controller coupled with a processor and a memory. The PEI controller is configured to start to use the negotiated PEIPS assistance information in response to receiving the negotiated PEIPS assistance information in the registration accept message. Further, the PEI controller is configured to stop to use the negotiated PEIPS assistance information in response to establishing PDU session over a 3GPP access. The PEI controller is configured to determine that at least one of a successful completion of a handover of the emergency PDU session from the 3GPP access to a non-3GPP access has occurred, or a successful transfer of the emergency PDU session in a fifth generation system (5GS) to an Evolved Packet Core (EPC), or an evolved packet data gateway (ePDG) connected to the EPC has occurred. Further, the PEI controller is configured to restart to use the negotiated PEIPS assistance information based on the determination.

Accordingly, the embodiments herein provide a UE comprising a PEI controller coupled with a processor and a memory. The PEI controller is configured to determine that the UE supporting NR paging subgrouping did not indicate its capability to support the NR paging subgrouping during a last registration procedure in response to determining that an emergency Packet Data Unit (PDU) session over a 3GPP access is active. Further, the PEI controller is configured to initiate a registration procedure for a mobility and periodic registration after an emergency PDU session is released or successful transfer of the emergency PDU session in a fifth generation system (5GS) over 3GPP access to an Evolved Packet Core (EPC), or an evolved packet data gateway (ePDG) connected to the EPC has occurred. Further, the PEI controller is configured to indicate a UE capability to support new radio (NR) paging subgrouping in a registration request message during the registration procedure.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts an example scenario, wherein a PEIPS feature has been disabled, on an emergency session being established over an N3GPP access, according to prior arts;

FIG. 2 depicts an example scenario, wherein the PEIPS feature has been disabled, on an emergency session being handed over to the N3GPP access, according to prior arts;

FIG. 3 depicts an example scenario, wherein the PEIPS feature is not enabled, after an emergency PDU session has been terminated, according to prior arts;

FIG. 4 depicts an example scenario, wherein there is no change of PEIPS feature, while an emergency session ongoing over other access (for example, Non-3GPP/EPC access), according to embodiments as disclosed herein;

FIG. 5 depicts an example scenario, wherein the PEIPS feature is re-enabled, on an emergency session being handed over to N3GPP access, according to embodiments as disclosed herein;

FIG. 6 depicts an example scenario, wherein the PEIPS feature is disabled while the emergency session is handed to 3GPP (5GC) Access, according to embodiments as disclosed herein;

FIG. 7 depicts an example scenario, wherein the NG-RAN is updated when PEIPS is disabled in AMF, according to embodiments as disclosed herein;

FIG. 8A depict an example scenario, wherein the UE initiates registration procedure and indicate PEIPS capability, on an emergency PDU session being terminated, according to embodiments as disclosed herein;

FIG. 8B depict an example scenario, wherein the UE initiates registration procedure and indicates PEIPS capability, on an emergency PDU session being terminated, according to embodiments as disclosed herein;

FIG. 9 shows various hardware components of a UE, according to the embodiments as disclosed herein;

FIG. 10 shows various hardware components of an AMF entity, according to the embodiments as disclosed herein;

FIG. 11 and FIG. 12 are flow charts illustrating a method, implemented by the UE, for handling the paging early indication with Paging Subgrouping Assistance (PEIPS) in the wireless network, according to the embodiments as disclosed herein; and

FIG. 13 is a flow chart illustrating a method, implemented by the AMF entity, for handling the paging early indication with Paging Subgrouping Assistance (PEIPS) in the wireless network, according to the embodiments as disclosed herein.

### MODE FOR INVENTION

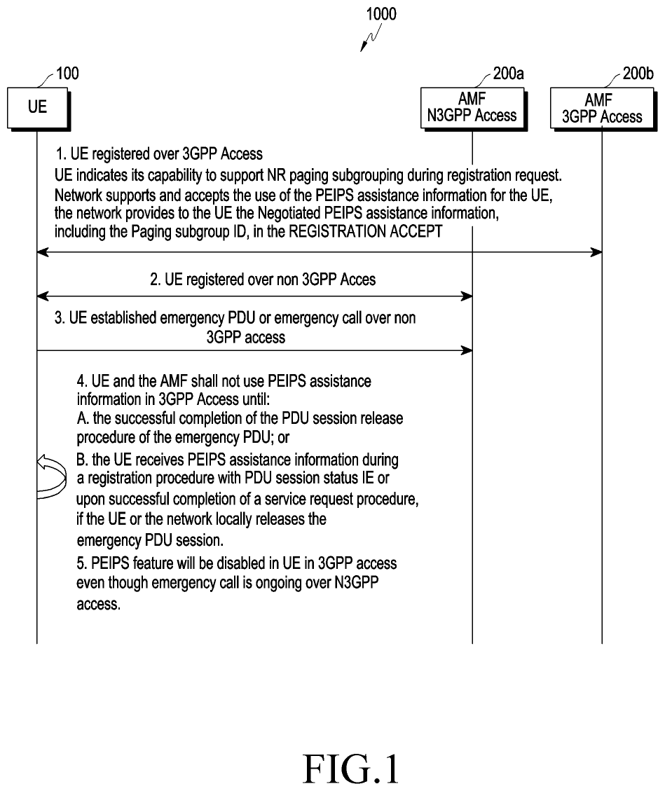

FIG. 1 depicts an example scenario, where a paging early indication with Paging Subgrouping Assistance (PEIPS) feature has been disabled, on an emergency session being established over N3GPP (non-3GPP) access (200a). In step 1, the UE (100) is registered over a 3GPP access (200b). The UE (100) indicates its capability to support NR paging subgrouping in a registration request message. A network supports and accepts the use of the PEIPS assistance information for the UE (100). The network provides the UE (100) with a negotiated PEIPS assistance information, including a Paging subgroup identifier (ID), in a registration accept. In step 2, the UE (100) registers over the non-3GPP Access (200b). In step 3, the UE (100) establishes the emergency PDU or emergency call over the non-3GPP access (200b). In step 4, the UE (100) and the AMF shall not use PEIPS assistance information in the 3GPP access (200b) until the successful completion of the PDU session release procedure of the emergency PDU; or the UE (100) receives the PEIPS assistance information during a registration procedure with PDU session status IE or upon successful completion of a service request procedure, if the UE (100) or the network locally releases the emergency PDU session. In step 5, the PEIPS feature will be disabled in the UE (100) in the 3GPP access (200b) even though emergency call is ongoing over N3GPP access.

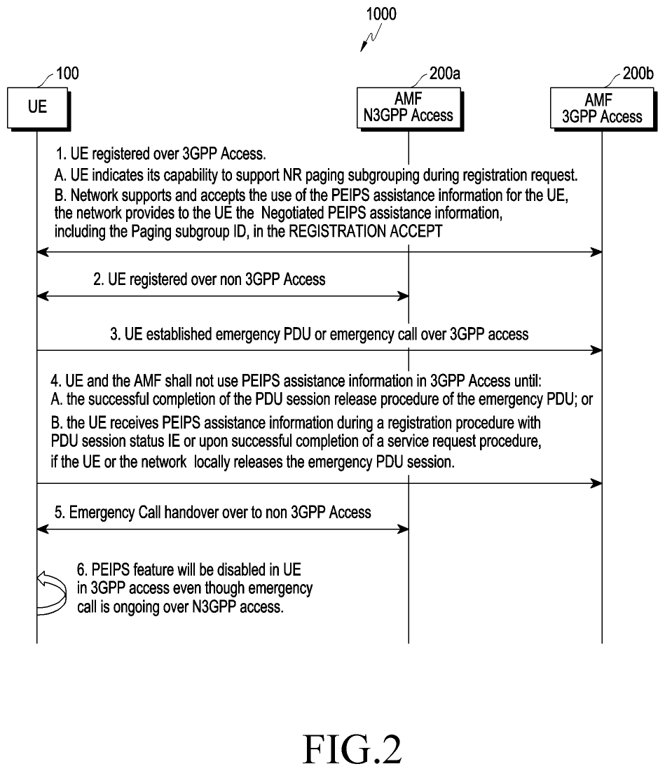

FIG. 2 depicts an example scenario, wherein the PEIPS feature has been disabled, on the emergency session being handed over to the N3GPP access (200a). In step 1, the UE (100) is registered over the 3GPP Access (200b). The UE (100) indicates its capability to support the NR paging subgrouping during the registration request. The network supports and accepts the use of the PEIPS assistance information for the UE (100). The network provides the UE (100) with the negotiated PEIPS assistance information, including the paging subgroup ID, in the registration accept. In step 2, the UE (100) registers over the non-3GPP Access (200a). In step 3, the UE (100) establishes the emergency PDU or the emergency call over the 3GPP access (200b). In step 4, the UE (100) and the AMF shall not use PEIPS assistance information in the 3GPP access (200b) until the successful completion of the PDU session release procedure of the emergency PDU, or the UE (100) receives the PEIPS assistance information during the registration procedure with PDU session status IE or upon successful completion of a service request procedure, if the UE (100) or the network locally releases the emergency PDU session. In step 5, the emergency call is handed over to the non-3GPP access (200a). In step 6, the PEIPS feature will be disabled in the UE (100) in the 3GPP access even though emergency call is handed over to N3GPP access (200a).

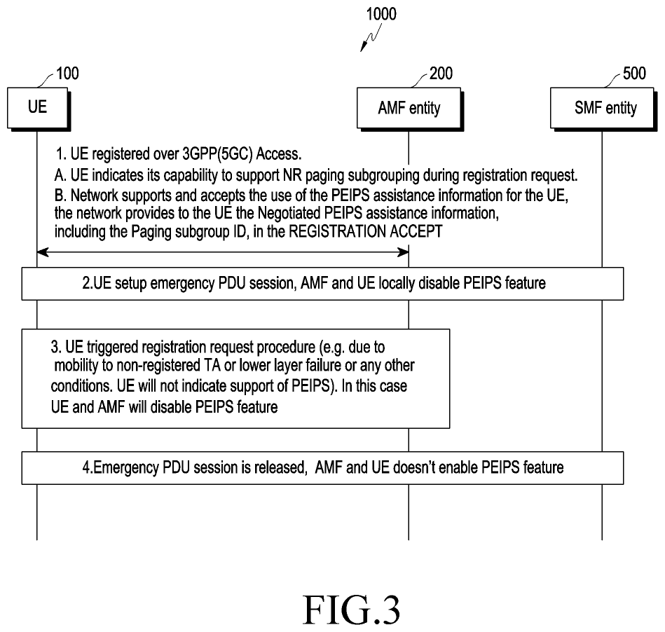

FIG. 3 depicts an example scenario, wherein the PEIPS feature is not enabled, after the emergency PDU session has been terminated over 3GPP access or successful transfer of the emergency PDU session in a fifth generation system (5GS) over 3GPP access to an Evolved Packet Core (EPC), or an evolved packet data gateway (ePDG) connected to the EPC has occurred. In step 1, the UE (100) is registered over the 3GPP Access. The UE (100) indicates its capability to support NR paging subgrouping during the registration request. The network supports and accepts the use of the PEIPS assistance information for the UE (100). The network provides the UE (100) with the negotiated PEIPS assistance information, including the paging subgroup ID, in the REGISTRATION ACCEPT. In step 2, the UE (100) sets up an emergency PDU session; the AMF and the UE (100) locally disable PEIPS. In step 3, the UE (100) triggers the registration request procedure (for example, due to mobility to non-registered tracking area (TA) or lower layer failure or any other conditions). The UE (100) will not indicate support of PEIPS. In this case, the UE (100) and the AMF will disable PEIPS feature. In step 4, on the emergency PDU session being released or successful transfer of the emergency PDU session in a fifth generation system (5GS) over 3GPP access to an Evolved Packet Core (EPC), or an evolved packet data gateway (ePDG) connected to the EPC has occurred, the AMF and the UE (100) do not enable PEIPS.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The following abbreviations have been used herein:
PEIPS: Paging Early Indication Paging Subgroup.
3GPP: 3^{rd} Generation Partnership Project.
N3GPP: Non 3^{rd} Generation Partnership Project.
AMF: Access and Mobility Function.
PDU: Packet Data Unit.
SMF: Session Management Function.
EPC: Evolved Packet Core.
ePDG: evolved packet data gateway.
HO: handover.
LTE: Long term evolution.
NR-PSSI: NR paging subgroup support indication.
IE: Information Element

The embodiments herein achieve methods for handling a paging early indication with Paging Subgrouping Assistance (PEIPS) in a wireless network (e.g., fifth generation (5G) network, an ORAN network or the like). The method includes triggering, by a UE, a registration procedure indicating support of a new Radio (NR) paging subgrouping. Further, the method includes starting to use, by the UE, a negotiated PEIPS assistance information in response to receiving the negotiated PEIPS assistance information in a registration accept message. Further, the method includes stopping to use, by the UE, the negotiated PEIPS assistance information in response to establishing emergency Packet Data Unit (PDU) session over a 3rd Generation Partnership Project (3GPP) access. Further, the method includes determining, by the UE or an Access and Mobility Function (AMF) entity, that at least one of: a successful completion of a handover of the emergency PDU session from the 3GPP access to a non-3GPP access has occurred, or a successful transfer of the emergency PDU session in a fifth generation system (5GS) to an Evolved Packet Core (EPC), or an evolved packet data gateway (ePDG) connected to the EPC has occurred. Further, the method includes restarting to use, by the UE or the AMF, the negotiated PEIPS assistance information based on the determination.

In an embodiment, if the UE supporting NR paging subgrouping did not indicate its capability to support NR paging subgrouping during the last registration procedure due to an active emergency PDU session over 3GPP access, the UE shall initiate a registration procedure for mobility and periodic registration update procedure to indicate its capability to support NR paging subgrouping after the emergency PDU session is released over the 3GPP access or a successful transfer of the emergency PDU session in a fifth generation system (5GS) over 3GPP access to a Evolved Packet Core (EPC), or an evolved packet data gateway (ePDG) connected to the EPC has occurred.

In an embodiment, the methods can be used to handle the paging early indication efficiently, where the Paging Early Indication Paging Subgroup (PEIPS) is disabled, when an emergency PDU session is HO to 3GPPA, or an emergency PDU session is activated over 3GPPA; and PEIPS is enabled back when the emergency PDU session is HO to N3GPPA, or an emergency PDU session is released over 3GPPA or a successful transfer of the emergency PDU session in a fifth generation system (5GS) over 3GPP access to a Evolved Packet Core (EPC), or an evolved packet data gateway (ePDG) connected to the EPC has occurred.

In an embodiment, the methods can be used to handle paging early indication efficiently, where the UE and the AMF shall not use Paging Early Indication Paging Subgroup (PEIPS) assistance information (i.e. PEIPS is disabled locally in the UE and the AMF), when an emergency PDU session is HO to 3GPPA (3GPP access) or an emergency PDU session is activated over 3GPPA; and the UE and the AMF shall use PEIPS assistance information (i.e. PEIPS is enabled locally in the UE and the AMF) when the emergency PDU session is HO to N3GPPA or an emergency PDU session is released over 3GPPA or a successful transfer of the emergency PDU session in a fifth generation system (5GS) over 3GPP access to a Evolved Packet Core (EPC), or an evolved packet data gateway (ePDG) connected to the EPC has occurred.

In an embodiment, the UE initiating registration procedure (e.g., Registration procedure for mobility and periodic registration update) to indicate its capability to support NR paging subgrouping in the REGISTRATION REQUEST message after the emergency PDU session is released or a successful transfer of the emergency PDU session in a fifth generation system (5GS) over 3GPP access to a Evolved Packet Core (EPC), or an evolved packet data gateway (ePDG) connected to the EPC has occurred, if the UE has indicated NR paging subgrouping is not supported in the previous REGISTRATION REQUEST message due to active emergency PDU session over 3GPP access.

In an embodiment, the UE indicating its capability to support NR paging subgrouping registration procedure (e.g. in the initial registration procedure or Registration procedure for mobility and periodic registration update), when emergency PDU session is not active on the 3GPP access on 5GC (i.e. emergency PDU session or PDN connection is active on non-3GPP access, EPC/ePDG) and if AMF support PEIPS feature then it shall provide Negotiated PEIPS assistance information in the registration accept.

In an embodiment, the UE indicates its capability to support NR paging subgrouping in the registration request carried in NR paging subgroup support indication (NR-PSSI) of the 5GMM capability information element sent along with REGISTRATION REQUEST message and its value is set to “NR paging subgrouping supported” or any other NAS IE.

In an embodiment, the UE has indicated NR paging subgrouping is not supported in the REGISTRATION REQUEST message carried in NR paging subgroup support indication (NR-PSSI) of the 5GMM capability information element sent along with REGISTRATION REQUEST message and its value is set to “NR paging subgrouping not supported” or any other NAS IE.

In this embodiment, the term “NR paging subgrouping supported” and “NR paging subgrouping not supported” is to indicate if the UE has the capability to support NR paging subgrouping or not.

In this embodiment, the term “PIEPS disables” is used for the case wherein the UE received the Negotiated PEIPS assistance information IE during the last registration procedure, but the UE and the AMF do not use PEIPS assistance information.

In this embodiment, the term “PIEPS enables” is used for the case, wherein the UE received the Negotiated PEIPS assistance information IE during the last registration procedure and start to use PEIPS assistance information.

In this embodiment, AMF 3GPP Access and AMF N3GPP access can be same node or different node.

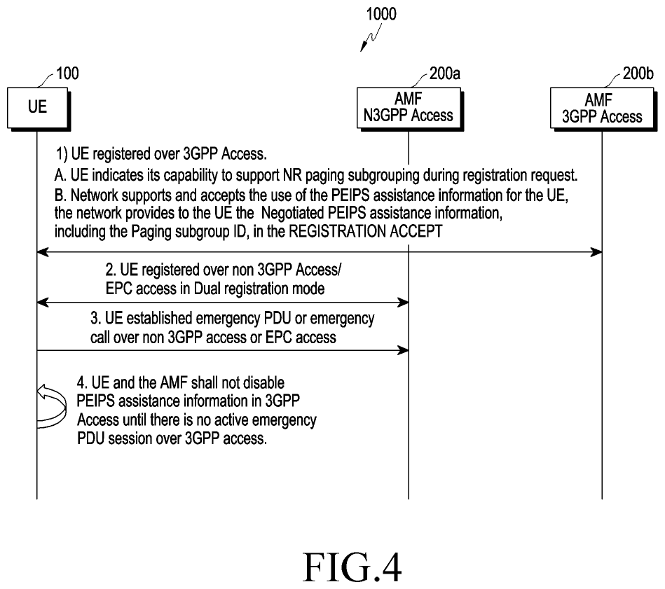

Referring now to the drawings, and more particularly to FIGS. 4 through 13, where similar reference characters denote corresponding features consistently throughout the figures, there are shown at least one embodiment.

FIG. 4 depicts an example scenario, wherein there is no change of PEIPS feature, while an emergency PDU session ongoing over other access (for example, non-3gpp/EPC (LTE in dual-registration mode or ePDG) access). In step 1, the UE (100) registers over the 3GPP Access (200b). The UE (100) indicates its capability to support NR paging subgrouping during the registration request. The network supports and accepts the use of the PEIPS assistance information for the UE (100). The network provides the UE (100) with the Negotiated PEIPS assistance information, including the paging subgroup ID, in the registration accept. In step 2, the UE (100) registers over the non-3GPP Access. In step 3, the UE (100) establishes emergency PDU or emergency call over non-3GPP access or EPC (e.g. LTE in dual-registration or ePDG). In step 4, the UE (100) and the AMF do not disable PEIPS assistance information in 3GPP Access until there is no active emergency PDU session over 3GPP access; i.e., the UE (100) and the AMF shall disable the PEIPS assistance information in 3GPP access, on the emergency PDU session being established over 3GPP access. In this case, when emergency PDU session or PDN connection is on the other access (e.g., on non-3GPP or EPC) and if the UE (100) need to send registration request in 3GPP access, the UE (100) indicates its capability to support NR paging subgrouping during the registration request.

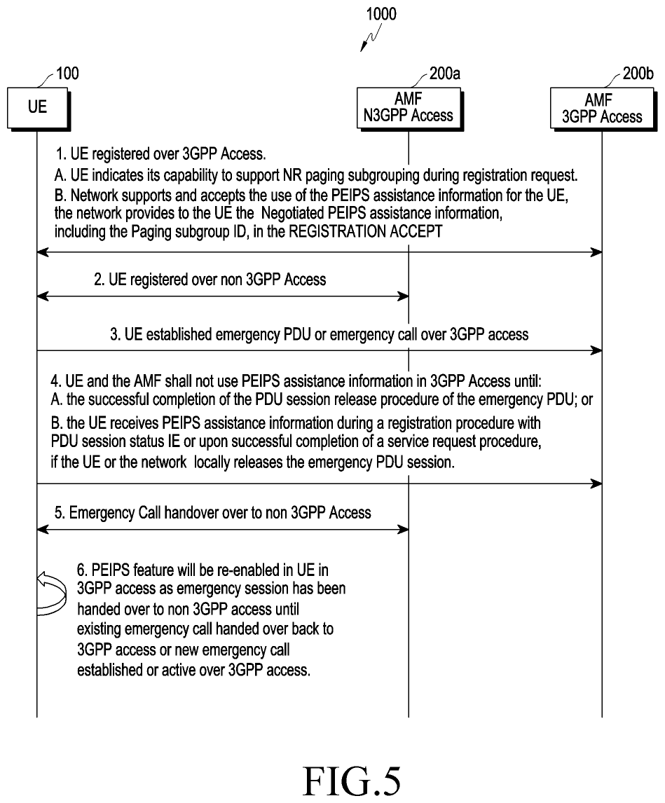

FIG. 5 depicts an example scenario, wherein the PEIPS feature is re-enabled, on the emergency session being handed over to the N3GPP access. In step 1, the UE (100) registers over the 3GPP Access (200b). The UE (100) indicates its capability to support NR paging subgrouping during the registration request. The network supports and accepts the use of the PEIPS assistance information for the UE (100). The network provides the UE (100) with the Negotiated PEIPS assistance information, including the paging subgroup ID, in the REGISTRATION ACCEPT. In step 2, the UE (100) registers over the non-3GPP Access (200a). In step 3, the UE (100) establishes the emergency PDU or emergency call over the 3GPP access (200b). In step 4, the UE (100) and the AMF shall not use PEIPS assistance information in the 3GPP Access (200b) until the successful completion of the PDU session release procedure of the emergency PDU; or the UE (100) receives the PEIPS assistance information during the registration procedure with the PDU session status IE or upon successful completion of the service request procedure, if the UE (100) or the network locally releases the emergency PDU session. In step 5, the emergency call is handed over to the non-3GPP access (200a) or to the EPC (LTE in dual-registration mode or ePDG). In step 6, the PEIPS feature will be re-enabled (AMF and UE (100) start to use PEIPS assistance information, if it has any) in the UE (100) in the 3GPP access (200b), as the emergency session has been handed over to non-3GPP access or to EPC (LTE in dual-registration mode or ePDG) until the existing emergency call is handed over back to 3GPP access or a new emergency call established or active over 3GPP access. In case the emergency PDU session is handed over to other access like non-3GPP or the EPC (LTE in Dual-registration or ePDG), the UE (100) and the AMF entity shall start using PEIPS assistance information received in the last registration procedure. In this case, when the emergency PDU session or the PDN connection is on the other access (e.g., on non-3GPP or EPC) and if the UE (100) needs to send registration request in 3GPP access, the UE (100) indicates its capability to support NR paging subgrouping in the REGISTREATION REQUEST message.

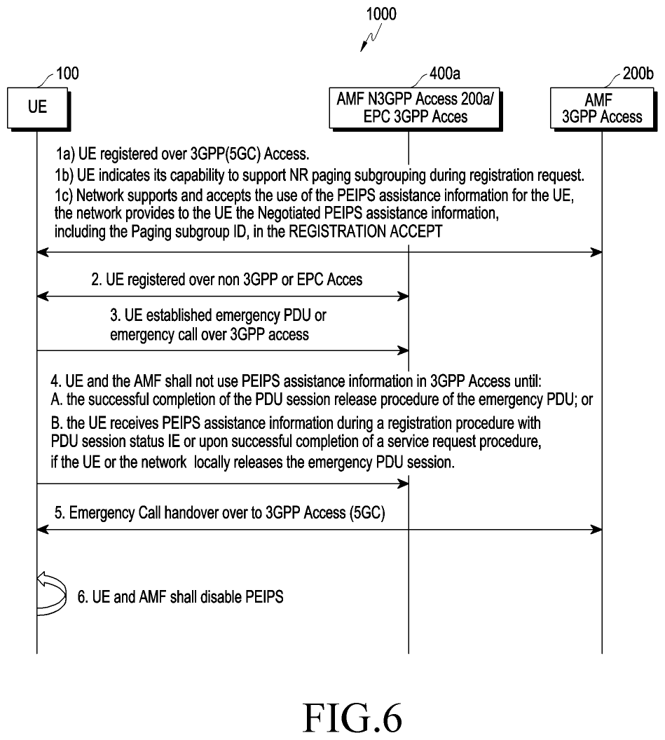

FIG. 6 depicts an example scenario, wherein the PEIPS feature is disabled while the emergency session is handed to 3GPP (5GC) Access. In step 1, the UE (100) registers over 3GPP (5GC) Access. The UE (100) indicates its capability to support NR paging subgrouping in the REGISTRATION REQUEST message. The network supports and accepts the use of the PEIPS assistance information for the UE (100). The network provides the UE (100) with the Negotiated PEIPS assistance information, including the paging subgroup ID, in the registration accept. In step 2, the UE (100) registers over the non-3GPP or EPC Access. In step 3, the UE (100) establishes the emergency PDU or the emergency call over the 3GPP access. In step 4, the UE (100) and the AMF shall not use PEIPS assistance information in 3GPP Access until the successful completion of the PDU session release procedure of the emergency PDU; or the UE (100) receives PEIPS assistance information during the registration procedure with PDU session status IE or upon successful completion of the service request procedure, if the UE (100) or the network locally releases the emergency PDU session. In step 5, the emergency call is handed over to 3GPP Access (5GC). In step 6, the UE (100) and the AMF shall disable PEIPS (AMF and UE (100) shall stop using PEIPS assistance information, if it has any). In this case, until emergency PDU session is on 3GPP access and if the UE (100) needs to send registration request in 3GPP access, the UE (100) does not indicate capability to support NR paging subgrouping.

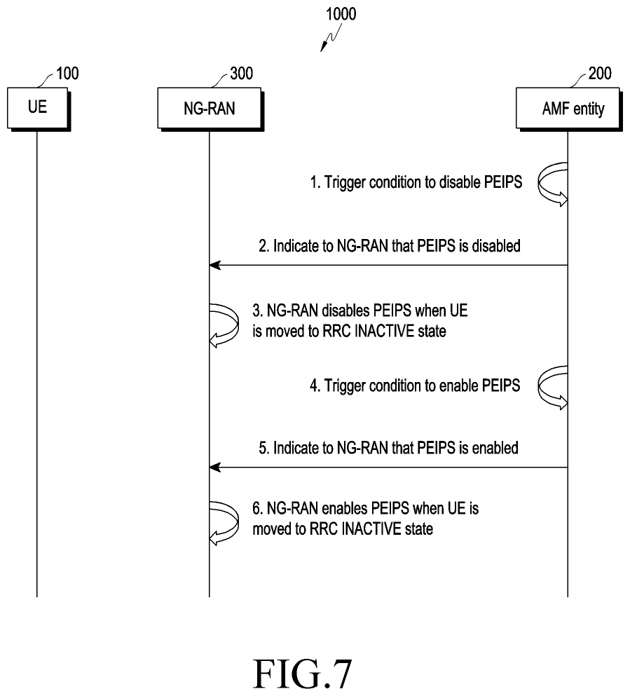

FIG. 7 depicts an example scenario, wherein the NG-RAN is updated when PEIPS is disabled in the AMF entity (200). In step 1, the AMF entity (200) triggers the condition to disable PEIPS. In step 2, the AMF entity (200) indicates to the NG-RAN that PEIPS is disabled. In step 3, the NG-RAN (300) disables PEIPS, when the UE (100) is moved to a RRC INACTIVE state. In step 4, the AMF entity (200) triggers a condition to enable PEIPS. In step 5, the AMF entity (200) indicates to the NG-RAN that PEIPS has been enabled. In step 6, the NG-RAN (300) enables PEIPS, when the UE (100) is moved to the RRC INACTIVE state.

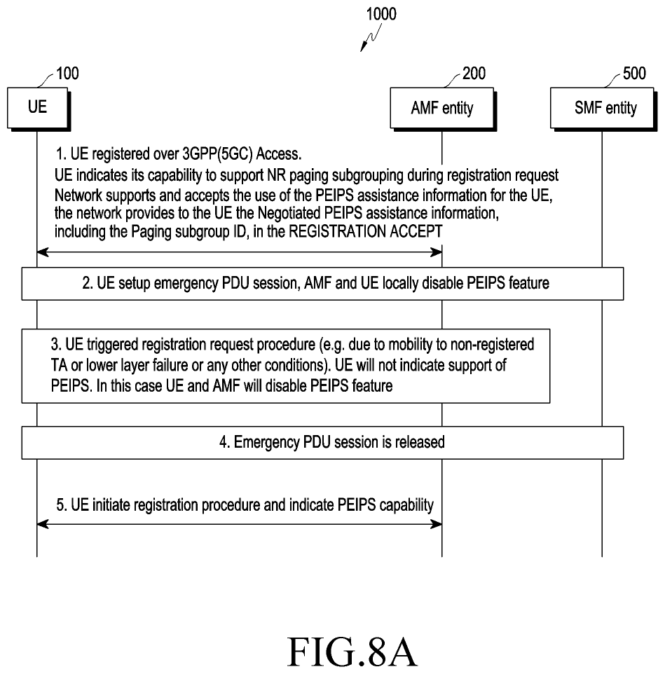

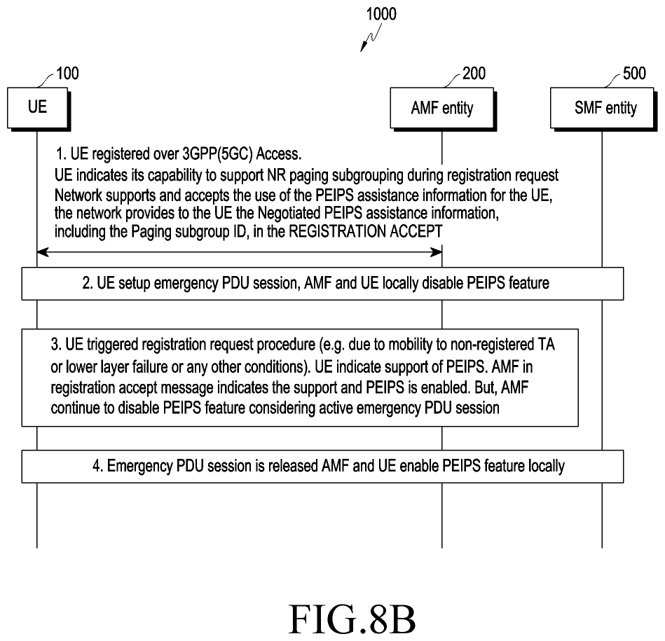

FIG. 8A depict an example scenario, wherein the UE (100) initiates the registration procedure and indicate PEIPS capability, on the emergency PDU session being terminated. In step 1, the UE (100) registers over the 3GPP (5GC) Access. The UE (100) indicates its capability to support NR paging subgrouping in the REGISTRATION REQUEST message. The network supports and accepts the use of the PEIPS assistance information for the UE (100). The network provides the UE (100) with the Negotiated PEIPS assistance information, including the Paging subgroup ID, in the REGISTRATION ACCEPT. In step 2, the UE (100) sets up an emergency PDU session; the AMF and the UE (100) locally disable PEIPS. In step 3, the UE (100) triggers the registration request procedure (for example, due to mobility to non-registered TA or lower layer failure or any other conditions). The UE (100) will not indicate capability to support NR paging subgrouping in the REGISTRATION REQUEST message. In this case, the UE (100) and the AMF will disable PEIPS. In step 4, the emergency PDU session is released. In step 5, the UE (100) initiates the registration procedure and indicates its capability to support NR paging subgrouping in the REGISTRATION REQUEST message. The UE (100) shall initiate registration procedure (registration procedure for mobility and periodic registration) after the emergency PDU session is released or a successful transfer of the emergency PDU session in a fifth generation system (5GS) over 3GPP access to a Evolved Packet Core (EPC), or an evolved packet data gateway (ePDG) connected to the EPC has occurred, if the UE (100) has not indicated capability to support NR paging subgrouping in the last registration procedure, due to an active emergency PDU session in the UE (100).

FIG. 8B depict an example scenario, wherein the UE (100) initiates registration procedure and indicates PEIPS capability, on an emergency PDU session being terminated. In step 1, the UE (100) registers over 3GPP (5GC) Access. The UE (100) indicates its capability to support NR paging subgrouping in the REGISTRATION REQUEST message. The network supports and accepts the use of the PEIPS assistance information for the UE (100). The network provides the UE (100) with the Negotiated PEIPS assistance information, including the Paging subgroup ID, in the REGISTRATION ACCEPT. In step 2, the UE (100) sets up an emergency PDU session; the AMF and the UE (100) locally disable PEIPS. In step 3, the UE (100) triggers the registration request procedure (for example, due to mobility to non-registered TA or lower layer failure or any other conditions). The UE (100) indicates its capability to support NR paging subgrouping in the REGISTRATION REQUEST message. The AMF provides the UE (100) with the Negotiated PEIPS assistance information, including the Paging subgroup ID, in the REGISTRATION ACCEPT. However, the AMF and the UE shall not to use PEIPS assistance information considering the active emergency PDU session. In step 4, on the emergency PDU session being released or a successful transfer of the emergency PDU session in a fifth generation system (5GS) over 3GPP access to an Evolved Packet Core (EPC), or an evolved packet data gateway (ePDG) connected to the EPC has occurred, the AMF and the UE (100) shall start using PEIPS assistance information, if it has any.

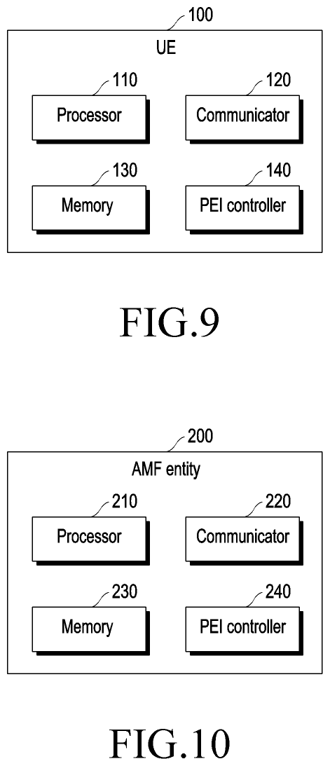

FIG. 9 shows various hardware components of the UE (100), according to the embodiments as disclosed herein. In an embodiment, the UE (100) includes a processor (110), a communicator (120), a memory (130) and a PEI controller (140). The processor (110) is coupled with the communicator (120), the memory (130) and the PEI controller (140).

The PEI controller (140) is configured to trigger the registration procedure indicating support of the NR paging subgrouping. Further, the PEI controller (140) is configured to start to use the negotiated PEIPS assistance information in response to receiving the negotiated PEIPS assistance information in the registration accept message. Further, the PEI controller (140) is configured to stop to use the negotiated PEIPS assistance information in response to establishing emergency PDU session over the 3GPP access. Further, the PEI controller (140) is configured to determine that at least one of: the successful completion of the handover of the PDU session from the 3GPP access to the non-3GPP access has occurred, or the successful transfer of the emergency PDU session in the 5GS to the EPC, or the ePDG connected to the EPC has occurred. Further, the PEI controller (140) is configured to restart to use the negotiated PEIPS assistance information based on the determination.

In another embodiment, the PEI controller (140) is configured to determine that the UE supporting NR paging subgrouping did not indicate its capability to support the NR paging subgrouping during the last registration procedure in response to determining that the PDU session over the 3GPP access is active. Further, the PEI controller (140) is configured to initiate the registration procedure for the mobility and periodic registration after the emergency PDU session is released or successful completion of the handover of the emergency PDU session from the 3GPP access to the non-3GPP access has occurred, or the successful transfer of the emergency PDU session in the 5GS to the EPC, or the ePDG connected to the EPC has occurred. Further, the PEI controller (140) is configured to indicate the UE capability to support the NR paging subgrouping in the registration request message during the registration procedure.

The PEI controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) (or transceiver) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 9 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

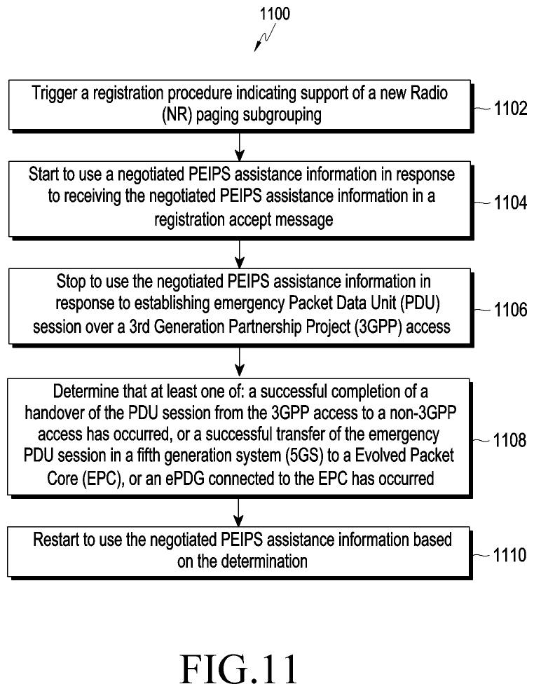

FIG. 10 shows various hardware components of the AMF entity (200), according to the embodiments as disclosed herein. In an embodiment, the AMF entity (200) includes a processor (210), a communicator (220), a memory (230) and a PEI controller (240). The processor (210) is coupled with the communicator (220), the memory (230) and the PEI controller (240).

The PEI controller (240) is configured to start to use the negotiated PEIPS assistance information in response to receiving the negotiated PEIPS assistance information in the registration accept message. Further, the PEI controller (240) is configured to stop to use the negotiated PEIPS assistance information in response to establishing emergency PDU session over the 3GPP access. The PEI controller (240) is configured to determine that at least one of a successful completion of a handover of the PDU session from the 3GPP access to the non-3GPP access has occurred, or the successful transfer of the emergency PDU session in the 5GS to the EPC, or the ePDG connected to the EPC has occurred. Further, the PEI controller (240) is configured to restart to use the negotiated PEIPS assistance information based on the determination.

The PEI controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) (or transceiver) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 10 shows various hardware components of the AMF entity (200) but it is to be understood that other embodiments are not limited thereon. In other embodiments, the AMF entity (200) may include less or more number of components. Further, the labels or names of the components are used only for illustrative purpose and does not limit the scope of the invention. One or more components can be combined together to perform same or substantially similar function in the AMF entity (200).

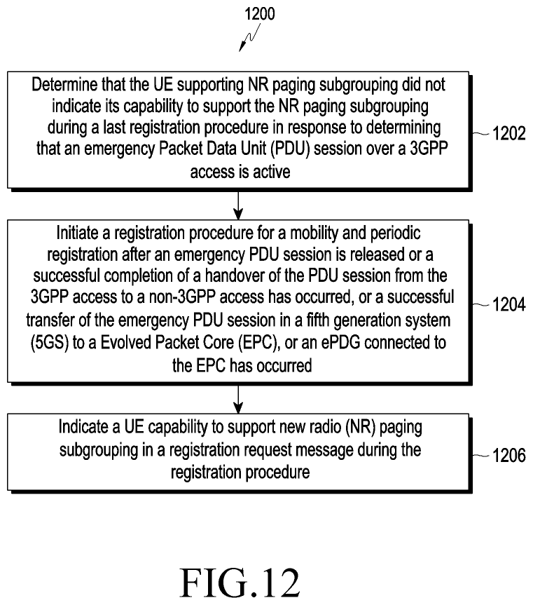

FIG. 11 and FIG. 12 are flow charts (1100 and 1200) illustrating a method, implemented by the UE (100), for handling the PEIPS in the wireless network (1000), according to the embodiments as disclosed herein.

As shown in FIG. 11, the operations (1102-1110) are handled by the PEI controller (140). At 1102, the method includes triggering the registration procedure indicating support of the NR paging subgrouping. At 1104, the method includes starting to use the negotiated PEIPS assistance information in response to receiving the negotiated PEIPS assistance information in the registration accept message. At 1106, the method includes stopping to use the negotiated PEIPS assistance information in response to establishing emergency PDU session over the 3GPP access. At 1108, the method includes determining that at least one of: the successful completion of the handover of the PDU session from the 3GPP access to the non-3GPP access has occurred, or the successful transfer of the emergency PDU session in the 5GS to the EPC, or the ePDG connected to the EPC has occurred. At 1110, the method includes restarting to use the negotiated PEIPS assistance information based on the determination.

As shown in FIG. 12, the operations (1202-1206) are handled by the PEI controller (140). At 1202, the method includes determining that the UE (100) supporting NR paging subgrouping did not indicate its capability to support the NR paging subgrouping during the last registration procedure in response to determining that the emergency PDU session over a 3GPP access is active. At 1204, the method includes initiating the registration procedure for the mobility and periodic registration after the emergency PDU session is released or successful completion of the handover of the emergency PDU session from the 3GPP access to the non-3GPP access has occurred, or the successful transfer of the emergency PDU session in the 5GS to the EPC, or the ePDG connected to the EPC has occurred. At 1206, the method includes indicating the UE capability to support the NR paging subgrouping in the registration request message during the registration procedure.

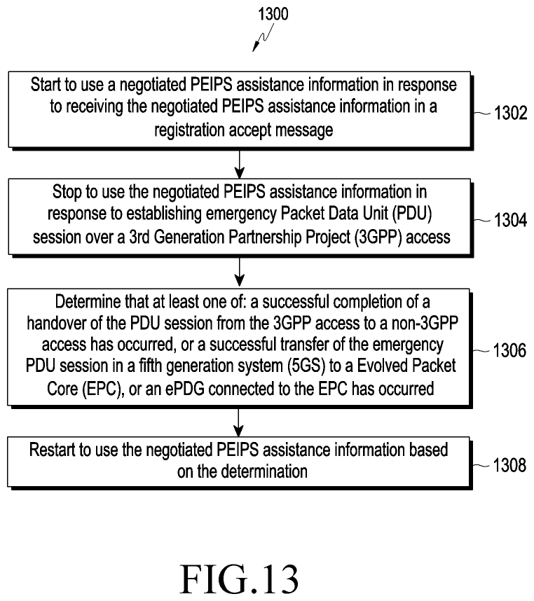

FIG. 13 is a flow chart (1300) illustrating a method, implemented by the AMF entity (200), for handling the PEIPS in the wireless network (1000), according to the embodiments as disclosed herein.

As shown in FIG. 13, the operations (1302-1308) are handled by the PEI controller (240). At 1302, the method includes starting to use the negotiated PEIPS assistance information in response to receiving the negotiated PEIPS assistance information in the registration accept message. At 1304, the method includes stopping to use the negotiated PEIPS assistance information in response to establishing emergency PDU session over the 3GPP access. At 1306, the method includes determining that at least one of: the successful completion of the handover of the PDU session from the 3GPP access to the non-3GPP access has occurred, or the successful transfer of the emergency PDU session in the 5GS to the EPC, or the ePDG connected to the EPC has occurred. At 1308, the method includes restarting to use the negotiated PEIPS assistance information based on the determination.

The method can be used to handle the paging early indication efficiently.

In an embodiment, A method for handling a paging early indication with Paging Subgrouping Assistance (PEIPS) in a wireless network (1000), comprising: triggering, by a User Equipment (UE) (100), a registration procedure indicating support of a new Radio (NR) paging subgrouping; starting to use, by the UE (100) and the Access and Mobility Function (AMF) entity (200), a negotiated PEIPS assistance information in response to receiving the negotiated PEIPS assistance information in a registration accept message; stopping to use, by the UE (100) and the Access and Mobility Function (AMF) entity (200), the negotiated PEIPS assistance information in response to establishing emergency Packet Data Unit (PDU) session over a 3rd Generation Partnership Project (3GPP) access; determining, by the UE (100) or an Access and Mobility Function (AMF) entity (200), that at least one of: a successful completion of a handover of the PDU session from the 3GPP access to a non-3GPP access has occurred, or a successful transfer of the emergency PDU session in a fifth generation system (5GS) to a Evolved Packet Core (EPC), or an evolved packet data gateway (ePDG) connected to the EPC has occurred; and restarting to use, by the UE (100) and the AMF entity (200), the negotiated PEIPS assistance information based on the determination.

In an embodiment, A method for handling a paging early indication (PEI) in a wireless network (1000), comprising: determining, by a User Equipment (UE) (100), that the UE (100) supporting NR paging subgrouping did not indicate its capability to support the NR paging subgrouping during a last registration procedure in response to determining that an emergency Packet Data Unit (PDU) session over a 3GPP access is active; initiating, by the UE (100), a registration procedure for a mobility and periodic registration after an emergency PDU session is released or a successful completion of a handover of the PDU session from the 3GPP access to a non-3GPP access has occurred, or a successful transfer of the emergency PDU session in a fifth generation system (5GS) to a Evolved Packet Core (EPC), or an ePDG connected to the EPC has occurred; and indicating, by the UE (100), a UE capability to support new radio (NR) paging subgrouping in a registration request message during the registration procedure.

In an embodiment, A User Equipment (UE) (100), comprising: a processor (110); a memory (130); and a PEI controller (140), coupled with the processor (110) and the memory (130), configured to trigger a registration procedure indicating support of a new Radio (NR) paging subgrouping; start to use a negotiated PEIPS assistance information in response to receiving the negotiated PEIPS assistance information in a registration accept message; stop to use the negotiated PEIPS assistance information in response to establishing emergency Packet Data Unit (PDU) session over a 3^{rd} Generation Partnership Project (3GPP) access; determine that at least one of: a successful completion of a handover of the PDU session from the 3GPP access to a non-3GPP access has occurred, or a successful transfer of the emergency PDU session in a fifth generation system (5GS) to a Evolved Packet Core (EPC), or an evolved packet data gateway (ePDG) connected to the EPC has occurred; and restart to use the negotiated PEIPS assistance information based on the determination.

In an embodiment, An Access and Mobility Function (AMF) entity (200), comprising: a processor (210); a memory (230); and a PEI controller (240), coupled with the processor (210) and the memory (230), configured to start to use a negotiated PEIPS assistance information in response to receiving the negotiated PEIPS assistance information in a registration accept message; stop to use the negotiated PEIPS assistance information in response to establishing emergency Packet Data Unit (PDU) session over a 3^{rd} Generation Partnership Project (3GPP) access; determine that at least one of: a successful completion of a handover of the PDU session from the 3GPP access to a non-3GPP access has occurred, or a successful transfer of the emergency PDU session in a fifth generation system (5GS) to a Evolved Packet Core (EPC), or an evolved packet data gateway (ePDG) connected to the EPC has occurred; and restart to use the negotiated PEIPS assistance information based on the determination.

In an embodiment, A User Equipment (UE) (100), comprising: a processor (110); a memory (130); and a PEI controller (140), coupled with the processor (110) and the memory (130), configured to determine that the UE supporting NR paging subgrouping did not indicate its capability to support the NR paging subgrouping during a last registration procedure in response to determining that an emergency Packet Data Unit (PDU) session over a 3GPP access is active; initiate a registration procedure for a mobility and periodic registration after an emergency PDU session is released or a successful completion of a handover of the PDU session from the 3GPP access to a non-3GPP access has occurred, or a successful transfer of the emergency PDU session in a fifth generation system (5GS) to a Evolved Packet Core (EPC), or an ePDG connected to the EPC has occurred; and indicate a UE capability to support new radio (NR) paging subgrouping in a registration request message during the registration procedure.

In an embodiment, a method performed by a user equipment (UE) in a wireless network, the method comprising: performing a registration procedure indicating support of a first paging subgrouping; receiving, from an access and mobility function (AMF) entity, a negotiated paging early indication with paging subgrouping (PEIPS) assistance information in a registration accept message during the registration procedure; using a PEIPS assistance information in response to receiving the negotiated PEIPS assistance information; establishing an emergency packet data unit (PDU) session over a first access network; stopping to use the PEIPS assistance information, in response to the establishing the emergency PDU session; performing handover procedure of the emergency PDU session from the first access network to a second access network; and in case that the emergency PDU session is handed over from the first access network to the second access network, using the PEIPS assistance information.

In addition, wherein the first access network is a 3rd Generation Partnership Project (3GPP) access and the second access network is a non-3GPP access.

In addition, wherein the negotiated PEIPS assistance information includes a paging subgroup identifier (ID).

In addition, wherein the first paging subgrouping is a new radio (NR) paging subgrouping.

In an embodiment, a method performed by a user equipment (UE) in a wireless network, the method comprising: determining that the UE supporting a first paging subgrouping did not indicate a capability to support the first paging subgrouping during a last registration procedure in response to determining that an emergency Packet Data Unit (PDU) session over a first access network is active; initiating a registration procedure for a mobility and periodic registration after the emergency PDU session is released over the first access network; and indicating the capability to support the first paging subgrouping during the registration procedure.

In addition, wherein the first access network is a 3rd Generation Partnership Project (3GPP) access.

In addition, wherein the first paging subgrouping is a new radio (NR) paging subgrouping.

In an embodiment, a method performed by a user equipment (UE) in a wireless network, the method comprising: performing a registration procedure indicating support of a first paging subgrouping; receiving, from a network entity, a negotiated paging early indication with paging subgrouping (PEIPS) assistance information in a registration accept message during the registration procedure; using a PEIPS assistance information in response to receiving the negotiated PEIPS assistance information; establishing an emergency Packet Data Unit (PDU) session over a first access network; stopping to use the PEIPS assistance information, in response to the establishing the emergency PDU session; performing transfer procedure of the emergency PDU session from a first network system to a second network system; and in case that the emergency PDU session is transferred from the first network system to the second network system, using the PEIPS assistance information.

In addition, wherein the first network system is a 5th generation system (5GS) and the second network system is an evolved packet system (EPS).

In an embodiment, a User Equipment (UE), comprising: a transceiver; and a processor configured to: perform a registration procedure indicating support of a first paging subgrouping; receive, from an access and mobility function (AMF) entity, a negotiated paging early indication with paging subgrouping (PEIPS) assistance information in a registration accept message during the registration procedure; use a PEIPS assistance information in response to receiving the negotiated PEIPS assistance information; establish an emergency packet data unit (PDU) session over the first access network; stop to use the PEIPS assistance information, in response to the establishing the emergency PDU session; perform handover procedure of the emergency PDU session from a first access network to a second access network; and in case that the emergency PDU session is handed over from the first access network to the second access network, use the PEIPS assistance information.

In an embodiment, A User Equipment (UE), comprising: a transceiver; and a processor configured to: determine that the UE supporting a first paging subgrouping did not indicate a capability to support the first paging subgrouping during a last registration procedure in response to determining that an emergency Packet Data Unit (PDU) session over a first access network is active; initiate a registration procedure for a mobility and periodic registration after the emergency PDU session is released over the first access network; and indicate the capability to support the first paging subgrouping during the registration procedure.

In an embodiment, A User Equipment (UE), comprising: a transceiver; and a processor configured to: perform a registration procedure indicating support of a first paging subgrouping; receive, from a network entity, a negotiated handling a paging early indication with paging subgrouping (PEIPS) assistance information in a registration accept message during the registration procedure; use a PEIPS assistance information in response to receiving the negotiated PEIPS assistance information; establish an emergency Packet Data Unit (PDU) session over the first access network; stop to use the PEIPS assistance information, in response to the establishing the emergency PDU session; perform transfer procedure of the emergency PDU session from a first network system to a second network system; and in case that the emergency PDU session is transferred from the first network system to the second network system, use the PEIPS assistance information.

The various actions, acts, blocks, steps, or the like in the flow charts (1100-1300) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method performed by a user equipment (UE) in a wireless network, the method comprising:
performing a registration procedure indicating support of a first paging subgrouping;
receiving, from an access and mobility function (AMF) entity, a negotiated paging early indication with paging subgrouping (PEIPS) assistance information in a registration accept message during the registration procedure;
using a PEIPS assistance information in response to receiving the negotiated PEIPS assistance information;
establishing an emergency packet data unit (PDU) session over a first access network;
stopping to use the PEIPS assistance information, in response to establishing the emergency PDU session;
performing a handover procedure of the emergency PDU session from the first access network to a second access network; and
in case that the emergency PDU session is handed over from the first access network to the second access network, using the PEIPS assistance information.

2. The method of claim 1, wherein the first access network is a 3rd Generation Partnership Project (3GPP) access and the second access network is a non-3GPP access.

3. The method of claim 1, wherein the negotiated PEIPS assistance information includes a paging subgroup identifier (ID).

4. The method of claim 1, wherein the first paging subgrouping is a new radio (NR) paging subgrouping.

5. A method performed by a user equipment (UE) in a wireless network, the method comprising:
determining that the UE supporting a first paging subgrouping did not indicate a capability to support the first paging subgrouping during a last registration procedure in response to determining that an emergency packet data unit (PDU) session over a first access network is active;
initiating a registration procedure for a mobility and a periodic registration update procedure after the emergency PDU session is released over the first access network; and
indicating the capability to support the first paging subgrouping.

6. The method of claim 5, wherein the first access network is a 3rd Generation Partnership Project (3GPP) access.

7. The method of claim 5, wherein the first paging subgrouping is a new radio (NR) paging subgrouping.

8. A method performed by a user equipment (UE) in a wireless network, the method comprising:
performing a registration procedure indicating support of a first paging subgrouping;
receiving, from a network entity, a negotiated paging early indication with paging subgrouping (PEIPS) assistance information in a registration accept message during the registration procedure;
using a PEIPS assistance information in response to receiving the negotiated PEIPS assistance information;
establishing an emergency packet data unit (PDU) session over a first access network;
stopping to use the PEIPS assistance information, in response to establishing the emergency PDU session;
performing a transfer procedure of the emergency PDU session from a first network system to a second network system; and
in case that the emergency PDU session is transferred from the first network system to the second network system, using the PEIPS assistance information.

9. The method of claim 8, wherein the first network system is a 5th generation system (5GS) and the second network system is an evolved packet system (EPS).

10. The method of claim 8, wherein the negotiated PEIPS assistance information includes a paging subgroup identifier (ID).

11. The method of claim 8, wherein the first paging subgrouping is a new radio (NR) paging subgrouping.

12. A user equipment (UE), comprising:
a transceiver; and
a processor configured to:
perform a registration procedure indicating support of a first paging subgrouping;
receive, from an access and mobility function (AMF) entity, a negotiated paging early indication with paging subgrouping (PEIPS) assistance information in a registration accept message during the registration procedure;
use a PEIPS assistance information in response to receiving the negotiated PEIPS assistance information;
establish an emergency packet data unit (PDU) session over a first access network;
stop to use the PEIPS assistance information, in response to establishing the emergency PDU session;
perform a handover procedure of the emergency PDU session from the first access network to a second access network; and
in case that the emergency PDU session is handed over from the first access network to the second access network, use the PEIPS assistance information.

13. The UE of claim 12, wherein the first access network is a 3rd Generation Partnership Project (3GPP) access and the second access network is a non-3GPP access.

14. The UE of claim 12, wherein the negotiated PEIPS assistance information includes a paging subgroup identifier (ID).

15. The UE of claim 12, wherein the first paging subgrouping is a new radio (NR) paging subgrouping.
